(19) United States
(12) Patent Application Publication
(10) Pub. No.: US 2026/0352307 A1
(43) Pub. Date: Nov. 5, 2026

(54) METHOD OF CONTROLLING A BASE STATION IN A TELECOMMUNICATIONS NETWORK, METHOD OF TRAINING A MACHINE LEARNING ALGORITHM FOR CONTROLLING A BASE STATION AND BASE STATION, USER EQUIPMENT AND COMPUTER SOFTWARE FOR PERFORMING THE METHODS

(71) Applicant: Vodafone Group Services Limited, Newbury, Berkshire (GB)

(72) Inventors: Diogo MARTINS, London (GB); Wael BOUKLEY HASAN, London (GB)

(21) Appl. No.: 19/487,144

(22) PCT Filed: May 23, 2024
(86) PCT No.: PCT/GB2024/051334

§ 371 Date: Nov. 24, 2025

(30) Foreign Application Priority Data
Jun. 12, 2023 (GB) 2308742.2

(51) Int. Cl. H04B 7/06

(52) U.S. Cl. CPC H04B 7/0693

(57) ABSTRACT

A method of controlling a base station in a telecommunications network, a method of training a machine learning algorithm for controlling a base station and a base station, User Equipment and computer software for performing the methods A method of controlling a base station in a telecommunications network is provided. The base station comprises a plurality of antenna ports. The method comprises communicating, from the base station to one or more User Equipments, UEs, one or more downstream signals. The method further comprises communicating, from the one or more UEs to the base station, one or more upstream signals comprising information obtained by or associated with the one or more UEs. The method further comprises using one or more algorithms to generate a model to selectively activate and/or deactivate one or more antenna ports of the plurality of antenna ports, based on data from the base station and the one or more upstream signals from the one or more UEs.

### FIELD OF THE INVENTION

The invention relates to methods of controlling a base station in a telecommunications network, based on channel quality data. In particular, the invention relates to methods of selectively activating and deactivating antenna ports in a base station, to improve efficiency.

### GLOSSARY

3GPP—3rd Generation Partnership Project
GSM—Global System for Mobile Communications
GSMA—GSM Association
UE—User Equipment
NR—New Radio (5G)
BS—Base Station
gNB—gNodeB
RF—Radio Frequency
CSI-RS—Channel State Information Reference Signals
QoS—Quality of Service
AI—Artificial Intelligence
ML—Machine Learning

### BACKGROUND

According to recent GSMA reports, such as “5G energy efficiencies: Green is the new black” by Tim Hatt et al., the energy cost for on mobile networks accounts for approximately 23% of the total operator cost. The majority of network energy usage is attributable to network base station sites. FIG. 1 illustrates an example from Vodafone®, which demonstrates that 73% of the energy use in 2022 is due to network base station sites.

A base station can be divided in two major parts, baseband and Radiofrequency (RF) frontend. The majority of the power consumption in the base station is due to the RF frontend, a large proportion of which can be attributed to components such as the Power Amplifier (PA), Low-Noise Amplifiers (LNA), Digital-to-Analog and Analog-to-digital (ADC/DAC) converters, and a variety of RF filters. These components compose the RF chains required to receive and transmit radio signals and convert them to and from the baseband frequency, before exchanging the signals with the baseband part of the base station for modulation/demodulation. An example of a configuration of a receiver RF chain is illustrated in FIG. 2.

Based on these observations, it is desirable to propose energy saving techniques that are standardised so that they can be applied universally. As a result, 3GPP Release 18provided a new framework for controlling the hardware components. Different domains were explored to tackle energy consumption from a base station: time, frequency, power and spatial. From the set of techniques evaluated, an enhancement to enable dynamic adaptation of spatial elements was chosen as a promising candidate. The overall aim of the framework is to specify physical layer enhancements to allow the activation/deactivation of antenna ports of a base station dynamically.

3GPP defines a concept of antenna port, which can be interpreted as the last point of the baseband part of the base station, thus being preceded by the RF frontend/RF chains of the base station. This means that activating/deactivating an antenna port would effectively deem all or part of the components within the RF chain to be turned on/turned off, as illustrated in FIG. 3. To implement the dynamic adaptation of spatial elements technique, the focus of the new framework is to specify enhancements to:
A) the Channel State Information Reference Signals (CSI-RS), which is a downlink reference signal sent by the gNB, and
B) the beam management framework.

As illustrated in FIG. 3, the base station 320 may be operated with all of the antenna ports active 330. By a process of antenna adaptation, a subset of the antenna ports may be deactivated 330′ to provide a different operating configuration of the base station 320′.

In NR, a UE is configured with a resource set of CSI-RS resources. A CSI-RS resource configuration contains information comprising the location where the UE can monitor the CSI-RS and also the type of signal being received, such as time and frequency location within the NR resource grid, number of antenna ports, bandwidth, and the like. The CSI-RS resource configuration thereby provides the UE with the required information to correctly demodulate the CSI signals. The CSI-RS signals are transmitted by the gNB and received by the UE, which performs measurements on the quality of CSI-RS signals (based on the configuration of CSI-RS resources) and reports this information back to the gNB in a CSI-RS report. The gNB is then able to perform beam management, link adaptation, cell reselection procedures, and the like, based on the information provided by the UE in the CSI-RS report. All the CSI-RS resource configurations are sent to the UE via RRC.

While the 3GPP standards have been updated in Release 18 to provide a framework for receiving CSI signals and sending CSI-RS reports taking into account spatial antenna patterns, there remains a need for a method of controlling a base station to reduce power consumption, making use of the new framework.

### SUMMARY

In order to implement the technique of spatial domain adaptation, the present invention proposes adaptations to the framework of CSI-RS resource configuration, CSI information, and CSI reporting.

A method of controlling a base station in a telecommunications network is provided. The base station comprises a plurality of antenna ports. The method comprises communicating, from the base station to one or more User Equipments, UEs, one or more downstream signals. The method further comprises communicating, from the one or more UEs to the base station, one or more upstream signals comprising information obtained by or associated with the one or more UEs. The method further comprises using one or more algorithms to generate a model to selectively activate and/or deactivate one or more antenna ports of the plurality of antenna ports, based on data from the base station and the one or more upstream signals from the one or more UEs.

The downstream signals may be signals comprising information. The downstream signals may be reference signals.

A step of “communicating” data can encompass transmitting the data or receiving the data. The step of “communicating” can be performed by either the transmitting or receiving device. For example, where the method step of communicating one or more downstream signals is performed by a base station, the step may comprise transmitting, by the base station, the one or more signals to one or more UEs. In another example, where the method step of communicating upstream signals from the one or more UEs to the base station, is performed by a base station, the step may comprise receiving, from the one or more UEs, the one or more upstream signals. Equally, the method could be performed elsewhere, such as a UE, in which case, communicating one or more signals may comprise receiving one or more signals from the base station. Likewise, communicating channel quality data from the one or more UEs to the base station may comprise sending channel quality data to the base station.

The information obtained by or associated with the one or more UEs may include information based on the signals received by the one or more UEs. The information obtained by or associated with the one or more UEs may include channel quality data. In other words, the upstream signals may comprise channel quality data based on the downstream signals received by the one or more UEs. The upstream signals corresponding to the downstream signals may comprise measurements indicative of a quality of a channel between the base station and the respective UE.

The downstream signals and/or the upstream signals may comprise one or more of:
reference signals;
key performance indicators, KPIs;
timestamp information;
measurements;
reports;
information relating to a channel between the base station and a respective UE; and location data.

The one or more upstream signals from the one or more UEs may further comprise timestamp information indicating when the corresponding one or more downstream signals were received by the respective UE.

The one or more upstream signals may comprise channel quality data from the one or more UEs and may further comprise timestamp information indicating when the one or more signals on which the channel quality data are based were received by the respective UE.

The downstream signals may be received during a first time period, the upstream signals may comprise a timestamp indicative of the first time period.

The timestamp may provide a reference timeline when the UE generates information for the upstream signals. The time when the UE received the downstream signals may be a different time to the time when the UE sends the upstream signals. The reference timeline provides an alignment between UE and gNB that allows for a better coordination between them. Improved coordination may be advantageous for the adaptation of the actions to create and enhance the model.

The method may further comprise determining, based on the timestamp information, a spatial pattern of the antenna ports corresponding to the one or more downstream signals transmitted by the base station. The upstream signals may correspond to the spatial pattern of the antenna ports.

The timestamp information may be used to align the occasions of the base station and UE data, which may be used to generate the model during the training phase. It may therefore be useful to include a timestamp as part of the data that can be used for model generation. However, the timestamp is not essential and may not be necessary for data used to activate/deactivate antenna ports (e.g., in the antenna port selection phase).

The method may further comprise communicating, from the base station to the one or more UEs, a spatial pattern of antenna ports corresponding to the one or more downstream signals. The method may further comprise determining that the upstream signals correspond to the spatial pattern of the antenna ports.

In some examples, the new framework defines that the CSI-RS resource configuration can be associated with a single spatial adaptation pattern or multiple spatial adaptation patterns. Within the resource set, the CSI-RS resource(s) can thus be associated with a pattern, and this configuration will allow the UE to perform measurements for a particular pattern and report it back to the base station.

As a result of these modifications to implement a spatial adaptation technique, a tool is provided to adapt the antenna ports of the gNB (both in terms of number or ports and spatial pattern) in a more dynamical/flexible way. Previous CSI-RS resources/reports do not accommodate reference to spatial domain patterns.

Controlling the base station to selectively activate and/or deactivate one or more of the plurality of antenna ports may comprise configuring a spatial pattern of the antenna ports. the spatial pattern may comprise a bit map.

Communicating channel quality data from the one or more UEs may comprise communicating one or more upstream signals periodically.

“Periodically” may be interpreted as “at regular intervals” or “intermittently”. Upstream signals may be communicated from the UE to the base station at regular intervals and/or at irregular intervals.

In other words, the method may comprise a plurality of regularly repeating cycles comprising the steps of:
communicating a set of downstream signals,
communicating upstream signals corresponding to the downstream signals.

Reporting of the CSI-RS measurements can be aperiodic, periodic or semi-persistent. For periodic reporting, the periodicity can vary between every 4 slots to 320 slots. The configurations may be performed via RRC.

The CSI-RS reports are one of the parameters for the training phase of the model (although may not be the only parameters). Therefore, the gNB may configure the periodicity accordingly with the type of training and algorithm to generate the model.

The periodicity/granularity of data sent form the UE to the base station during the training phase may depend on the type of training and type of AI/ML model requirements and implementation.

Each set of upstream signals may comprise a timestamp indicative of the time period of the corresponding downstream signals. The model may be used to selectively activate and/or deactivate the one or more antenna ports during the regularly repeating cycles. The one or more algorithms may be used to update the model during the regularly repeating cycles.

The one or more upstream signals may comprise a plurality of reports. Each report may be based on downstream signals received by the one or more UEs during a respective time period. Each report may comprise a timestamp indicative of the time period of the corresponding downstream signals. In other words, the upstream signals may comprise a first report (e.g., comprising channel quality data) based on downstream signals received during a first time period and a second report based on downstream signals received during a second time period different to the first time period.

In other words, each report may contain quality data for signals received at multiple different times.

The reporting granularity may also be increased in certain examples. This may be enabled by defining that a CSI-RS report may contain multiple sub-reports/sub-configurations that contain information referring to one or multiple spatial domain patterns. With the information gathered by the UE CSI-RS reports, the gNB can adapt its spatial domain pattern accordingly by implementation.

Additional granularity may be included in the CSI-RS reports and will be associated with the spatial patterns (either single patterns or multiple patterns). The periodicity may be unchanged from previous CSI-RS reporting.

The model may be configured to selectively activate and/or deactivate one or more of the antenna ports of the plurality of antenna ports in order to manage a power consumption of the base station while maintaining a required performance at the one or more UEs.

The algorithm may be configured to maintain performance at the one or more Ues above a threshold level (e.g., a minimum QoS requirement). The threshold level may be based on a channel quality measured by the UE, based on the downstream signals. In some cases, it may not always be possible for channel quality at every one of the Ues to be above the threshold level at all times. For example, if the UE is in an area of poor signal, such as a basement.

The QoS may be measured in terms of one or more KPIs or “metrics”, such as a measured channel quality, RSRP/RSRPP/RSTD, RSTD, LOS/NLOS indicator, RSRPP, throughput, L1-RSRP, L1-SINR, BLER, hypothetical BLER, EVM, data quality indicator, SRS, CSI-RS, CSI reporting, RI and CQI.

The method may further comprise training the algorithm to develop the model using labeled data for training and testing the model. The labeled data may comprise a plurality of records. Each record may correspond to a moment in time. Each record may comprise one or more operational parameters comprising a spatial pattern of antenna ports. Each record may further comprise one or more key performance indicators, KPIs, corresponding to the spatial pattern of antenna ports.

The one or more KPIs may comprise information obtained by or associated with a UE that has received downstream signals from a base station. The KPIs correspond with the spatial pattern of antenna ports so may relate to downstream signals received from a base station configured to transmit those downstream signals in accordance with the spatial pattern of antenna ports.

For example, the one or more KPIs may comprise channel quality data based on downstream signals received one or more Ues.

The one or more KPIs may further comprise an indication of power consumption.

Alternatively, it may be assumed that fewer antenna ports being active in the spatial pattern results in lower power consumption.

The algorithm may be a machine learning algorithm. The model may be an AI model, such

as a neural network.

The telecommunications network may be a 5G network. The base station may be a gNodeB. Each of the one or more downstream signals may be a Channel Status Information Reference Signal, CSI-RS. The upstream signals may comprise one or more CSI-RS Reports from each of the one or more UEs.

A method of training an algorithm to generate and/or develop a model for controlling a base station comprising a plurality of antenna ports and in communication with one or more User Equipments, UEs, is also provided. The model is configured to selectively activate and/or deactivate one or more antenna ports of the plurality of antenna ports in order to manage a power consumption of the base station while maintaining a required performance at the one or more UEs. The method comprises communicating, from a base station to one or more UEs, one or more downstream signals. The method further comprises communicating, from each of the one or more UEs to the base station, one or more upstream signals corresponding to the one or more downstream signals and comprising information obtained by or associated with the respective UE. The method further comprises determining a spatial pattern of antenna ports corresponding to the one or more downstream signals. The method further comprises training the algorithm using labeled data for training and/or testing the model. The labeled data comprises a plurality of records. Each record corresponds to a period of time. Each record comprises one or more operational parameters comprising a spatial pattern of antenna ports. Each record further comprises information obtained by or associated with a UE and corresponding to the spatial pattern of antenna ports.

The one or more upstream signals may comprise channel quality data based on the corresponding downstream signals received by the UE.

The information obtained by or associated with the respective UE may comprise one or more KPIs. The KPIs may comprise channel quality data based on the one or more downstream signals received by the UE.

The period of time may be the period during which the downstream signals were received by the UE.

The method may further comprise communicating (e.g., in the one or more downstream signals), from the base station to the one or more UEs, a spatial pattern of antenna ports corresponding to the one or more downstream signals. Determining a spatial pattern of antenna ports corresponding to the one or more downstream signals may comprise receiving the spatial pattern from the base station, along with the corresponding one or more downstream signals.

The method may further comprise communicating (e.g., in the one or more upstream signals), from each of the one or more UEs to the base station, timestamp information indicating when the corresponding one or more downstream signals were received by the respective UE.
Wherein determining a spatial pattern of antenna ports corresponding to the one or more downstream signals comprises determining the corresponding spatial pattern of the antenna ports based on the timestamp information.

The timestamp information may indicate when the corresponding one or more downstream signals on which signal measurements, such as channel quality data, are based.

A base station configured to perform the methods described above is also provided.

A User Equipment, UE, configured to perform the methods described above is also provided.

Computer software that, when executed by a processor, causes the processor to perform the methods described above is also provided.

The proposed methods, base stations, UEs and computer software may be used to manage the antenna ports of the base station in a more flexible way. These methods, base stations, UEs and computer software may also be used to reduce power consumption of the base station and/or improve/maintain channel quality between the base station and the UEs.

These advantages may be brought about as a result of the proposed methods, base stations, UEs and computer software, without requiring historical data to train the model in advance. The model may be trained on-the-fly, based on data generated during operation of the system.

Additionally/alternatively, there may be great amounts of mobile network data that are available to aid the application of the spatial domain adaptation techniques described above. These data may be used to train the machine learning algorithm used in the proposed methods. By making use of this historical data, the performance of the machine learning algorithm may be improved.

A mobile operator may perform antenna port/cell deactivation/activation using criteria based on data/KPIs, such as traffic load, number of users, cell and user throughput, among others. With this, it will be possible to bring about network energy savings, while also reducing the impact on the Quality of Service (QOS) of customers.

### BRIEF DESCRIPTION OF THE DRAWINGS

FIG. 1 illustrates example mobile network provider energy usage.

FIG. 2 illustrates a RF chain example for a receiver.

FIG. 3 illustrates an antenna port shutdown example.

FIG. 4 illustrates an example telecommunications network.

FIG. 5 illustrates the life cycle management (LCM) phase of an AI/ML model.

FIG. 6 illustrates a flowchart for an example method of the LCM phase of a ML/AI model.

FIG. 7 illustrates the antenna port selection phase of an AI/ML model.

FIG. 8 illustrates a flowchart for an example method of the antenna port selection phase of an AI/ML model.

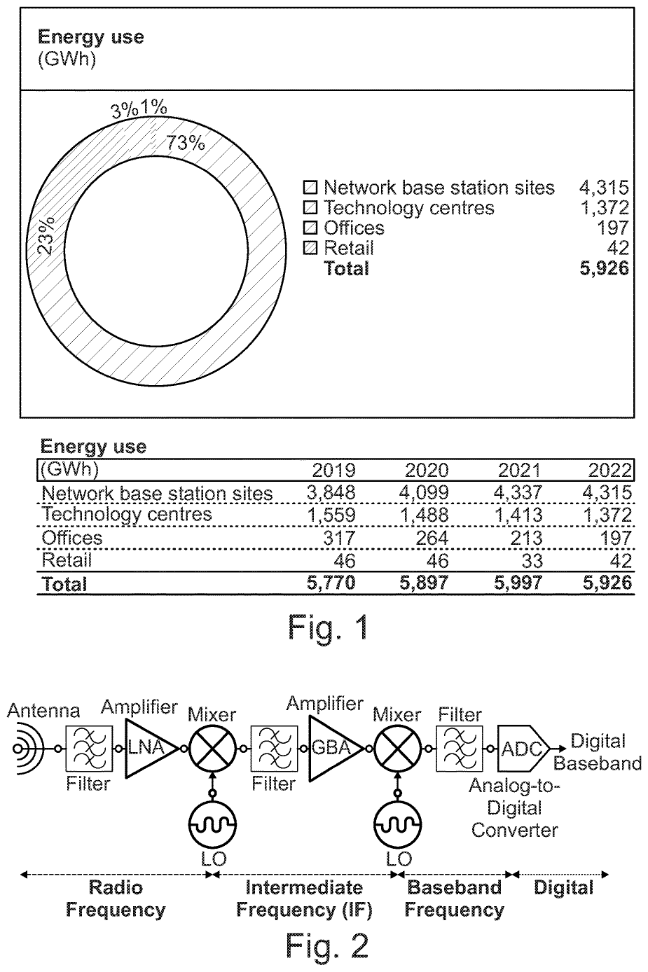

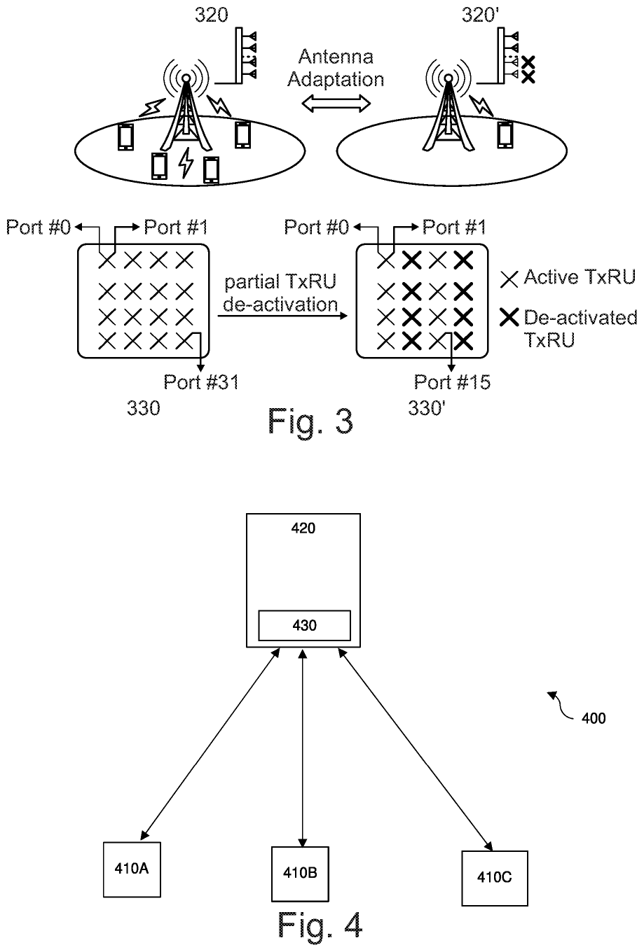

### DETAILED DESCRIPTION

An example telecommunications network 400 in which the proposed methods may be implemented is illustrated in FIG. 4. The telecommunications network comprises a base station 420, which may be a gNB, and one or more UEs 410A-410C. The base station 420 comprises a plurality of antenna ports 430. The base station 420 transmits one or more downstream signals to the UEs 410A-410C. The UEs 410A-410C transmit one or more upstream signals to the base station 420, corresponding to the one or more downstream signals. The one or more upstream signals comprise information obtained by or associated with the respective one or more UEs.

Based on data from the base station (such as a precoding matrix) and the upstream signals from the one or more UEs, a model is configured to selectively activate and/or deactivate one or more antenna ports of the plurality of antenna ports.

One or more algorithms may be used to generate the model. These algorithms may be run at the base station 420, the UEs 410A-410C, a third party server, or a combination of these.

The downstream signals may be reference signals. The upstream signals may comprise channel quality data based on the reference signals received from the base station.

To perform the decision on the activation/deactivation of the antenna ports, a framework based on AI/ML algorithms is used to create a model with enhanced data collection of several KPIs from the network and/or UE side. The model provides an output that translates to the adaptation of the antenna ports, aiming to optimize network energy savings.

Recent changes in 3GPP standards, which provide an NR air interface, have facilitated the adoption of the AI/ML frameworks described in this application. The proposed methods target a number of specific use cases, including:
CSI feedback enhancement (such as overhead reduction, improved accuracy and improved prediction);
Beam management (such as beam prediction in time and/or spatial domain for overhead and latency reduction, beam selection accuracy improvement); and
Positioning accuracy enhancements for different scenarios, such as those with heavy NLOS conditions.

The set of possible use cases may require different strategies for data collection, in terms of granularity and periodicity. Depending on the desired use case, the model lifecycle can be tailored in terms of training, testing, and inference phases. Collaboration levels between the gNB and the UEs can also be adjusted to fit the required use.

Data obtained from a variety of these use cases can be used to train the model for activation/deactivation of antenna ports. The model may also be used on a larger scale for activation/deactivation of cells/sectors.

In view of the 3GPP enhancements in Release 18 relating to spatial adaptation of antenna ports, the spatial pattern of the antenna ports may be provided as one of the KPI inputs for the model generation. The measurements on the CSI-RS associated with spatial patterns can also be used as an input during the training phase (or “LCM” phase) of the model.

Using AI/ML to control which antenna ports need to be activated and/or deactivated at the gNB can be broken down into two main constituent phases. The first phase is associated with the life cycle management (LCM) phase of the AI/ML model. The second phase is associated with activating and deactivating the antenna ports (antenna port selection phase) at the BS side.

The AI/ML model can be created at the gNB or the UE, partially or impartially. The LCM phase of the model can consist of all or any of the following phases: model training, model deployment, model inference, model monitoring and model updating. During the LCM phase, configuration/signalling between gNB and UE is required to initiate the LCM of the model and/or to update its status. Furthermore, KPIs, measurement reports, part of the model or the whole model can be exchanged between gNB and UE during the LCM.

Some measurements are not included in the CSI-RS reports and therefore are only available at the UE. For example, an idle/inactive mode measurement may be available at the UE and this measurement may be used to train the model. Some data may only be available at the base station, such as a precoding matrix of the RF chain. As a result the training of the model may be distributed between the UE and the base station in some examples.

During the LCM phase, there are several ways to develop the framework (which may be performed sequentially or simultaneously). In each way, it is preferable that reporting of KPIs from the UE to base station is enhanced. Each way may also utilise base station KPIs. The periodicity and granularity of the collected data may be varied to suit the requirements of the use case. Several types of data can also be considered, including both data that the base station has access to from legacy operation, but also new types of data for the collection and enhancement of existing KPI and measurement reports.

For the antenna port selection phase at the gNB, the model that was created during the LCM phase is then used to generate an output which is then translated to the antenna port activation/deactivation. This phase will also depend on the type of training that was employed, and also the periodicity of when it can be implemented.

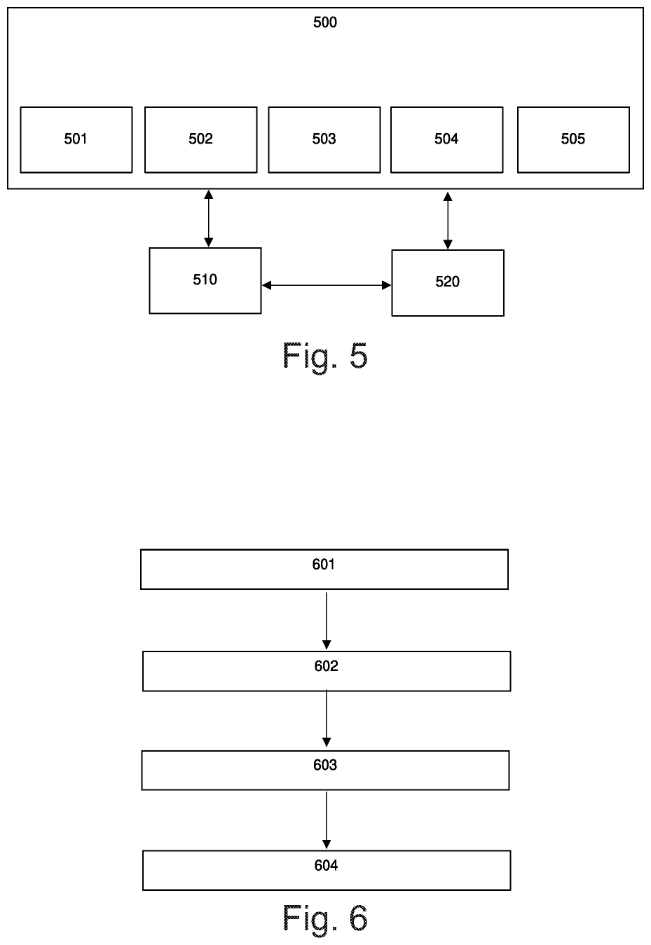

FIG. 5 illustrates the LCM phase of a ML/AI model 500 according to one example. There are several phases involved in LCM, including:
501: Model updating
502: Model monitoring
503: Model inference
504: Model deployment
505: Model training

Signalling/configuration, and data transfer from/to UE 510 and gNB 520 is illustrated using bi-directional arrows, to indicate that data is exchanged in both directions. The AI/ML model 500 can be created at the gNB 520 or the UE 510, partially or impartially. In other words, the model 500 may be created entirely at the gNB 520, the model 500 may be created entirely at the UE 510 (e.g., partially at each of a plurality of UEs), or the model 500 may be created partially at the UE 510 and partially at the gNB 520. The AI/ML model 500 provides a framework for activation/deactivation of antenna ports at the gNB 520.

FIG. 6 illustrates a flowchart for an example method of the LCM phase of a ML/AI model. The method comprises generating and/or developing the model, which is for controlling a base station comprising a plurality of antenna ports and in communication with one or more User Equipments, UEs. The model is configured to selectively activate and/or deactivate one or more antenna ports of the plurality of antenna ports in order to manage a power consumption of the base station while maintaining a required performance at the one or more UEs. The method comprises the following steps:
601: communicating, from a base station to one or more UEs, one or more downstream signals;
602: communicating, from each of the one or more UEs to the base station, one or more upstream signals corresponding to the one or more downstream signals and comprising information obtained by or associated with the respective UE;
603: determining a spatial pattern of antenna ports corresponding to the one or more downstream signals; and
604: training the algorithm using labeled data for training and/or testing the model, the labeled data comprising a plurality of records, each record corresponding to a period of time and comprising:
   one or more operational parameters comprising a spatial pattern of antenna ports; and
   information obtained by or associated with a UE and corresponding to the spatial pattern of antenna ports.

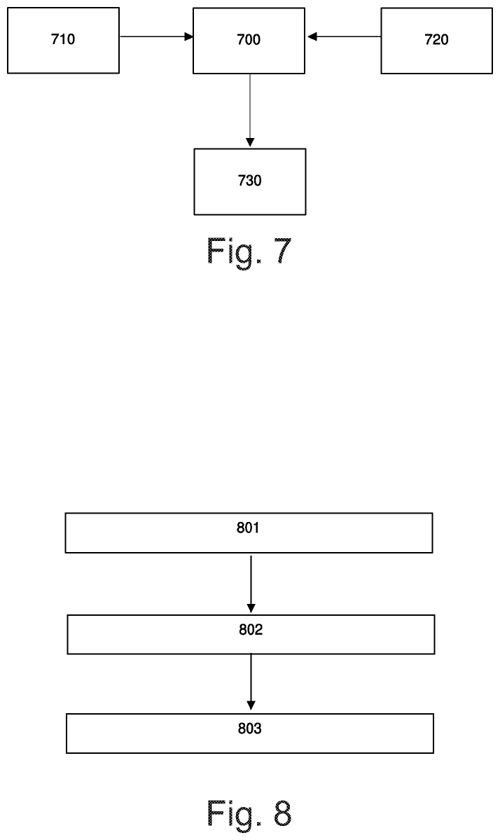

FIG. 7 illustrates the antenna port selection phase of a ML/AI model 700 according to one example. The AI/ML model that was generated from the LCM phase is used here. The input(s) to the AI/ML model are from the UE 710 and/or gNB 720. The ML/AI model 700 is used to activate/deactivate the antenna ports 730.

Data transfer from/to UE 710 and gNB 720 may include KPIs, measurement reports, part of the model or the whole model. The following are some examples of the KPI and measurement reports: RSRP/RSRPP/RSTD, RSTD, LOS/NLOS indicator, RSRPP, RS configurations, throughput, L1-RSRP, L1-SINR, BLER, hypothetical BLER, EVM, time stamps, cell ID, data quality indicator, SRS, CSI-RS, CSI reporting, precoding matrix, precoding matrix in spatial-frequency domain, precoding matrix represented using angular-delay domain projection, raw channel in spatial-frequency domain, raw channel in angular-delay domain, RI and CQI.

AI/ML techniques or other suitable techniques may include deep learning, reinforced or unreinforced machine learning, neural networks, K-means clustering, regression analysis, and/or other suitable techniques, analyses, computations, or the like.

The outcome of the antenna port selection phase contains information about activating and deactivating antenna ports at the gNB 720 including, but not limited to, a bit map corresponding to antenna ports/panels, among others.

FIG. 8 illustrates a flowchart for an example method of the antenna port selection phase of a ML/AI model. The model is used to control a base station comprising a plurality of antenna ports. The method comprises the following steps:
801: communicating, from the base station to one or more UEs one or more downstream signals;
802: communicating, from the one or more UEs to the base station, one or more upstream signals corresponding to the one or more downstream signals and comprising information obtained by or associated with the one or more UEs; and
803: using one or more algorithms to generate a model to selectively activate and/or deactivate one or more antenna ports of the plurality of antenna ports, based on data from the base station and the upstream signals from the one or more UEs.

Some outcomes and consequences from activate/deactivate antenna ports method are:
1) Change the energy consumption at the BS side.
2) Change in the cell/sector coverage area.
3) Activating/deactivating cells/sectors.

Any of the methods described herein may be implemented as a computer program. The computer program may be configured to control a base station and/or UE to perform any method according to the disclosure. A base station and/or a UE may also be provided, configured to operate in accordance with certain methods disclosed herein. For example, a base station may include a processor and at least one communication interface, particularly comprising one or both of a transmitter and receiver. A UE may likewise include a processor and at least one communication interface, particularly comprising one or both of a transmitter and receiver.

It will be appreciated that the methods described in this application may be performed at one or more corresponding entities in the network. For example, the above-mentioned functionality may be implemented by one or more UEs, one or more base stations and/or one or more other entities in the network.

Although specific embodiments have been described, the skilled person will understand that various modifications and variations are possible. For example, whilst the disclosure is described in relation to existing network architecture, it will be understood that changes to the architecture (and/or nomenclature) are possible, but the present disclosure may still be applicable in this case. Also, combinations of any specific features shown with reference to one embodiment or with reference to multiple embodiments are also provided, even if that combination has not been explicitly detailed herein.

A base station may be referred to as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology, depending on the protocol, standard, context or technology. In some examples, a base station may include two or more transceivers that may or may not be collocated. Each transceiver may communicate on the same or different carrier frequency within the same or different frequency band.

Where this application refers to a server or network entity, for instance, this may actually be a pair of servers, or network entities (primary and failover), for redundancy.

Whilst the above methods are described in relation to a 5G network, these methods, techniques, apparatuses, and systems may be applied to a variety of wireless systems.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In the above description, a base station is referred to as a gNB.

In the present invention, a cell refers to a prescribed geographical area to which one or more nodes provide a communication service. Accordingly, in the present invention, communicating with a specific cell may mean communicating with an gNB or a node which provides a communication service to the specific cell. Furthermore, channel status/quality of a specific cell refers to channel status/quality of a channel or communication link formed between an gNB or node which provides a communication service to the specific cell and a UE. The UE may measure DL channel state received from a specific node using channel state information reference signal(s) (CSI-RS(s)) transmitted on a CSI-RS resource, allocated by antenna port(s) of the specific node to the specific node. Meanwhile, a 3GPP system uses the concept of a cell in order to manage radio resources and a cell associated with the radio resources is distinguished from a cell of a geographic region.

The examples may be carried out on any suitable data processing device, such as a personal computer, laptop, mobile telephone, server, virtual machine, and the like. The above description of the systems and methods has been simplified for purposes of discussion, and is intended to provide a specific example to illustrate the invention. Different types of systems and methods may be used, as will be appreciated by the skilled person. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules. Moreover, multiple method steps implemented in flowcharts contained herein, or as described above, may be implemented together by a single module.

Examples may be implemented by computer software or a “computer program”. A storage medium and a transmission medium carrying the computer software are also provided. The computer software may comprise one or more instructions, or code, that, when executed by a computer, causes the methods described to be performed. Computer software may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as a UE, a node, a network entity, a RAN entity, or a cell) means “one or more” (for instance one or more UE, one or more nodes, one or more network entities, one or more RAN entities, or one or more cells). Throughout the description and claims of this disclosure, the words “comprise”, “including”, “having” and “contain” and variations of the words, for example “comprising” and “comprises” or similar, mean “including”, and are not intended to (and do not) exclude other components.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise. Moreover, where a step is described as being performed after a step, this does not preclude intervening steps being performed.
All of the aspects and/or features disclosed in this specification may be combined in any combination, except combinations where at least some of such features and/or steps are mutually exclusive. As described herein, there may be particular combinations of aspects that are of further benefit, such the aspects of determining a set of compensation parameters and applying a set of compensation parameters to measurements. In particular, the preferred features of the invention are applicable to all aspects of the invention and may be used in any combination. Likewise, features described in non-essential combinations may be used separately (not in combination).

A method of manufacturing and/or operating any of the devices disclosed herein is also provided. The method may comprise steps of providing each of the features disclosed and/or configuring or using the respective feature for its stated function.

1. A method of controlling a base station in a telecommunications network, wherein the base station comprises a plurality of antenna ports, the method comprising:
communicating, from the base station to one or more User Equipments, UEs, one or more downstream signals;
communicating, from the one or more UEs to the base station, one or more upstream signals corresponding to the one or more downstream signals and comprising information obtained by or associated with the one or more UEs;
using one or more algorithms to generate a model to selectively activate and/or deactivate one or more antenna ports of the plurality of antenna ports, based on data from the base station and the one or more upstream signals from the one or more UEs.

2. The method of claim 1, wherein the one or more downstream signals and/or the one or more upstream signals comprise one or more of:
reference signals;
key performance indicators, KPIs;
timestamp information;
measurements;
reports;
information relating to a channel between the base station and a respective UE of the one or more UEs; and
location data.

3. The method of claim 2, wherein the one or more upstream signals from the one or more UEs further comprise timestamp information indicating when the corresponding one or more downstream signals corresponding thereto were received by the respective UE.

4. The method of claim 3, further comprising:
determining, based on the timestamp information, a spatial pattern of a subset of the antenna ports corresponding to the one or more downstream signals transmitted by the base station, wherein the one or more upstream signals correspond to the spatial pattern of the subset of the antenna ports.

5. The method of claim 1, further comprising:
communicating, from the base station to the one or more UEs, a spatial pattern of a subset of the antenna ports corresponding to the one or more downstream signals; and
determining that the one or more upstream signals correspond to the spatial pattern of the subset of the antenna ports.

6. The method of claim 1, wherein controlling the base station to selectively activate and/or deactivate one or more antenna ports of the plurality of antenna ports comprises configuring a spatial pattern of the antenna ports.

7. The method of claim 1, wherein communicating one or more upstream signals from the one or more UEs comprises communicating one or more upstream signals periodically.

8. The method of claim 1, wherein the one or more upstream signals comprise a plurality of reports, wherein each report of the plurality of reports is based on downstream signals received by the one or more UEs during a respective time period.

9. The method of claim 1, wherein the model is configured to selectively activate and/or deactivate the one or more antenna ports of the plurality of antenna ports in order to manage a power consumption of the base station while maintaining a required performance at the one or more UEs.

10. The method of claim 9, wherein the method further comprises training the algorithm to develop the model using labeled data for training and testing the model, the labeled data comprising a plurality of records, each record of the plurality of records corresponding to a moment in time and comprising:
one or more operational parameters comprising a spatial pattern of antenna ports; and/or
one or more key performance indicators, KPIs, corresponding to the spatial pattern of antenna ports.

11. The method of claim 1:
wherein the telecommunications network is a 5G network;
wherein the base station is a gNodeB; and/or
wherein the one or more downstream signals comprise one or more Channel Status Information Reference Signals, CSI-RS; and/or
wherein the one or more upstream signals received from the one or more UEs comprise one or more CSI Reports from each of the one or more UEs.

12. A method of training an algorithm to generate and/or develop a model for controlling a base station comprising a plurality of antenna ports and in communication with one or more User Equipments, UEs, wherein the model is configured to selectively activate and/or deactivate one or more antenna ports of the plurality of antenna ports in order to manage a power consumption of the base station while maintaining a required performance at the one or more UEs, the method comprising:
communicating, from the base station to the one or more UEs, one or more downstream signals;
communicating, from a respective UE of the one or more UEs to the base station, one or more upstream signals corresponding to the one or more downstream signals and comprising information obtained by or associated with the respective UE;
determining a spatial pattern of a subset of the antenna ports corresponding to the one or more downstream signals; and
training the algorithm using labeled data for training and/or testing the model, the labeled data comprising a plurality of records, each record of the plurality of records corresponding to a period of time and comprising:
one or more operational parameters comprising a spatial pattern of antenna ports; and
information obtained by or associated with a UE and corresponding to the spatial pattern of antenna ports.

13. The method of claim 12, further comprising:
communicating, from the base station to the one or more UEs, the spatial pattern of the subset of the antenna ports corresponding to the one or more downstream signals,
wherein determining the spatial pattern of the subset of the antenna ports corresponding to the one or more downstream signals comprises receiving the spatial pattern from the base station, along with the one or more downstream signals corresponding thereto.

14. The method of claim 13, further comprising:
communicating, from the respective UE of the one or more UEs to the base station, timestamp information indicating when the one or more downstream signals were received by the respective UE.

15. The method of claim 14, wherein determining the spatial pattern of the subset of the antenna ports corresponding to the one or more downstream signals comprises determining the spatial pattern of the subset of the antenna ports based on the timestamp information.

16. A base station configured to perform the method of claim 1.

17. A UE configured to perform the method of claim 1.

18. A computer program product comprising a non-transitory computer readable storage medium having computer readable program code embodied therein that, when executed by a processor, causes the processor to perform the method of claim 1.
